(19) United States
(12) Patent Application Publication
(10) Pub. No.: US 2013/0032441 A1
(43) Pub. Date: Feb. 7, 2013

(54) MOUNTING UNIT AND BRAKE DISK WITH THE MOUNTING UNIT

(71) Applicants: Hyundai Motor Company, Seoul (KR); DACC Co., Ltd., Changwon-Si (KR)

(72) Inventors: Seong Jin Kim, Yongin (KR); Yeon Ho Choi, Tongyeong (KR); Hyun Kuk Park, Jeonju (KR); Jeong Suk Kang, Jeonju (KR)

(73) Assignees: DACC Co., Ltd., Changwon-Si (KR); Hyundai Motor Company, Seoul (KR)

(21) Appl. No.: 13/645,774

(22) Filed: Oct. 5, 2012

Related U.S. Application Data
(62) Division of application No. 12/345,260, filed on Dec. 29, 2008.

(30) Foreign Application Priority Data
Sep. 3, 2008 (KR) 10-2008-0086978

(51) Int. Cl. F16D 65/12

(52) U.S. Cl. 188/218 XL

(57) ABSTRACT

Disclosed is a mounting unit including a bushing having a main part having a penetration hole extending in a lengthwise direction thereof and a flange portion expanding from an upper end of the main part, a stripper bolt having a head portion, a body portion having an insert portion to be inserted into or received in the penetration hole, and a male screw-threaded portion at a leading end of the insert portion. Also disclosed is a brake unit assembled using the mounting unit that has good thermal and mechanical stability at a coupling portion between a disk rotor and a rotor hat.

### CROSS-REFERENCE TO RELATED APPLICATIONS

This application claims under 35 U.S.C. §119(a) priority to Korean Application No. 10-2008-0086978, filed on Sep. 3, 2008, the disclosure of which is incorporated herein by reference in its entirety.

### BACKGROUND OF THE INVENTION

1. Technical Field

The present invention relates to a mounting unit and a brake disk in which a rotor hat is installed on a disk rotor using the mounting unit. The brake disk comprises the disk rotor and the rotor hat made of different materials and has a stable structure owing to the mounting unit

2. Background Art

Vehicles generally brake using a friction brake which changes the kinetic energy of vehicles to frictional thermal energy and dissipates it into the air. Disk brakes which are a kind of friction brakes are structured so as to put pressure on opposite surfaces of the brake disk which rotates along with the wheels by pressing brake pads against the brake disk with pneumatic pressure.

Generally, brake disks have been made of cast iron, but brake disks made of carbon-fiber-reinforced carbon-ceramic (C_{f}/C—SiC) composites (ceramic-matrix composites) having excellent braking characteristics, such as braking stability, anti-abrasion, and anti-corrosion are also being developed. These types of brake disks cannot be manufactured into a single body by a casting method using known techniques. Accordingly, in these innovative brake systems, a disk rotor having a frictional surface with which a brake pad comes into contact is suitably manufactured using a C_{f}/C—SiC composite, a rotor hat to be mounted in a hub connected to a drive shaft of a vehicle is suitably manufactured using a metal, and the rotor hat is preferably mounted in the disk rotor.

When mounting the rotor hat onto the disk rotor, a tubular coupling member, such as a bolt is preferably used. As a result, a strong shearing force is generated at a border between the disk rotor and the rotor hat and may create problem at a coupling portion between the disk rotor and the rotor hat, when the shearing force is transferred to the bolt which penetrates through both the disk rotor and the rotor hat. FIG. 1 is an exemplary diagram illustrating this effect. With reference to FIG. 1, if the shearing force is applied to a bushing 1, the force is transferred to the bolt 2 and the bolt 2 may be inclined in one direction, whereby a crack can occur at the border between a main part 1a and a sleeve 1b of the bushing 1 which is in contact with the disk rotor 100, and thus damage can be caused to the disk rotor 100 which is made of a C_{f}/C—SiC composite that is softer than metal. Further, the thermal expansion difference between the disk rotor 100 made of a C_{f}/C—SiC composite and the bushing 1 made of a metal, and the thermal stress that is attributable, to the thermal expansion difference, may further aggravate such problems.

The mounting unit 1 shown in FIG. 1 is structured in such a mariner that a leading end of the bolt 2 is preferably combined with a main part 11 of the bushing 1 and a nut 30 in a screwed manner. In such a structure, it is required to combine a disk rotor 100 and a rotor hat 200 by making the bushing 10 and the bolt 2 penetrate through holes after precisely aligning the holes of the disk rotor 100 and the rotor hat 200 with each other. Accordingly, assemblability and operation efficiency can be lowered. The reference numeral 4 indicates a washer.

The above information disclosed in this the Background section is only for enhancement of understanding of the background of the invention and therefore it may contain information that does not form the prior art that is already known in this country to a person of ordinary skill in the art.

### SUMMARY OF THE INVENTION

The invention provides a disk brake which is capable of suitably maintaining thermal and mechanical stability at a coupling portion between a disk rotor preferably made of a composite and a rotor hat preferably made of a metal under a braking condition of high temperature heat generation.

The invention also provides a mounting unit which can preferably allow a disk brake to be easily assembled.

The invention preferably provides a mounting unit including a bushing with a flange expanding from an upper end of a main part thereof which has a penetration hole extending in a lengthwise direction, a stripper bolt having a head portion, a body portion with an insert portion to be suitably inserted and received in the penetration hole at a leading end thereof, and a male screw portion formed to protrude from the leading end of the insert portion, and a nut to be suitably mated with the male screw.

In certain embodiments, it is preferable that the insert portion and the penetration hole have corresponding shapes so as to limit rotation of the insert portion in the penetration hole.

In other certain embodiments, it is preferable that the main part be shorter than a length of the penetration hole.

In other certain embodiments, it is preferable that a border between the main part and the insert portion be provided with a sill by which a lower end of the bushing is supported or stopped.

In further embodiments, it is preferable that the nut be provided with a tapered wing which gradually decreases toward a leading end and has an inside surface with female screwed threads thereon so that a male screwed portion is preferably pressed against the nut.

The invention also provides a brake disk including a disk rotor having one or more lower holes at a center portion thereof, a rotor hat having an upper hole corresponding to the lower hole at a peripheral, portion thereof, and a mounting unit which suitably combines the rotor hat to the disk rotor.

In certain embodiments, it is preferable that the mounting unit includes a bushing having a main part which is suitably received in the upper hole and has a penetration hole extending in a lengthwise direction and a flange portion expanding from an upper end of the main part; and a tubular coupling member preferably penetrating through the lower hole and the penetration hole and having one end fixed to the disk rotor and the other end fixed to the rotor hat.

In certain embodiments, it is preferable that rotation of the main part is suitably limited in the upper hole and a lower end of the main part be separated from the disk rotor.

In other certain embodiments, it is preferable that rotation of the coupling member is suitably limited, in the penetration hole and the coupling member be the stripper bolt and nut.

In certain embodiments, it is preferable that the insert portion can have a suitably flat surface in plane contact with the inside surface of the penetration hole.

According to preferred embodiments of the above-mentioned invention as described herein, since the bushing is not directly in plane contact with the disk rotor made of a composite and stress from the rotor hat made of a metal is suitably applied to the bushing but is not transferred to the stripper bolt, thermal and mechanical stability at a coupling portion between the disk rotor and the rotor hat can be maintained.

In preferred embodiments, the disk brake is suitably assembled in a manner such that the upper hole and the lower hole are roughly aligned with each other, the stripper bolt is preferably inserted so as to suitably penetrate through from the lower hole to the upper hole, and the bushing and the nut are sequentially coupled to the stripper bolt in order. Accordingly, it is possible to reduce a burden of precisely aligning the holes with each other in an assembly process of the disk brake (it is difficult to align the upper hole with the lower hole because the shape and size of the upper and lower holes are different) and it is possible to suitably improve the convenience of assembly of the disk brake.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric, vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated, in and form a part of this specification, and the following Detailed Description, which together serve to explain by way of example the principles of the present invention.

### BRIEF DESCRIPTION OF THE DRAWINGS

The above and other features and advantages of the present invention will be more clearly understood from the following detailed description when taken in conjunction with the accompanying drawings, in which:

FIG. 1 is a sectional view illustrating a brake disk to which a mounting unit according to a known art is applied;

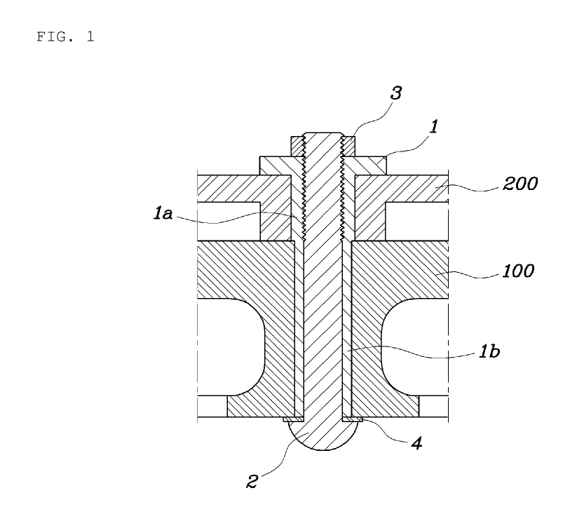

FIG. 2 is a view illustrating a process of assembling a mounting unit according to one embodiment of the invention;

FIG. 3 is a view illustrating a process of assembling a brake disk according to one embodiment of the invention; and

FIG. 4 is a sectional view taken along A-A of FIG. 3 which shows an assembled state of the brake disk according to one embodiment of the invention.

### DETAILED DESCRIPTION

As described herein, the present invention includes mounting unit used for installing a first part on a second part, comprising a bushing having a main part having a penetration hole extending in a lengthwise direction thereof and a flange portion expanding from an upper end of the main part a stripper bolt having a head portion, a body portion having an insert portion, and a male screw-threaded portion, wherein the insert portion and the penetration hole have corresponding shapes to prevent rotation of the insert portion in the penetration hole, and a nut to be mated with the male screw-threaded portion.

In one embodiment, the insert portion of the stripper bolt is to be inserted into or received in the penetration hole.

In another embodiment, the male screw-threaded portion is at a leading end of the insert portion.

The present invention also includes a brake disk comprising a disk rotor with one or more lower holes provided at a center portion thereof, a rotor hat with an upper hole which corresponds to the lower hole and is provided at a center portion thereof; and a mounting unit which couples the rotor hat the disk rotor, wherein the mounting unit includes a main part received in the upper hole and provided with a penetration hole and a flange portion, wherein rotation of the main part is limited in the upper hole and a lower end of the main part is separated from the disk rotor, and a tubular coupling member.

In one embodiment, the penetration hole of the main part is extending in a lengthwise direction.

In another embodiment, the flange portion of the main part is formed to expand from an upper end of the main part.

In a further embodiment, the tubular coupling member penetrates through the lower hole and the penetration hole and has one end fixed to the disk rotor and the other end fixed to rotor hat.

The invention also features a motor vehicle comprising the mounting unit as described in any of the embodiments herein.

The invention also features a motor vehicle comprising the brake disk as described in any one of the embodiments herein.

Hereinafter, a mounting unit and a brake disk according to preferred embodiments of the invention will he described with reference to the accompanying drawings.

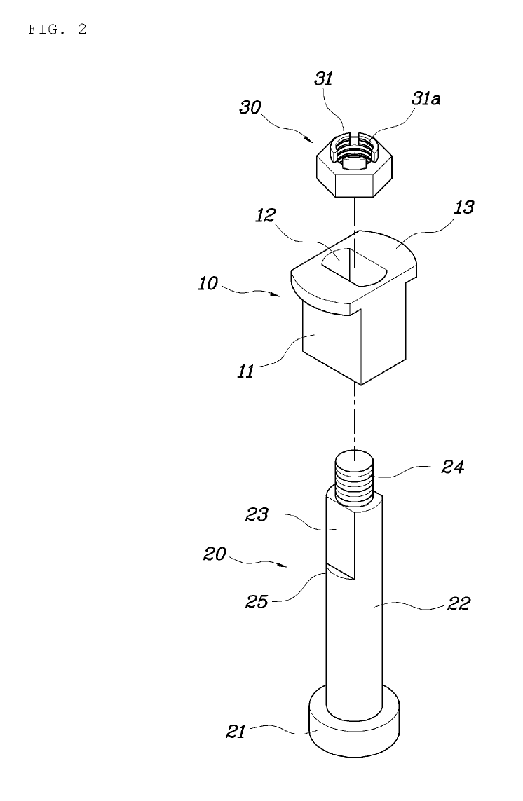

In preferred embodiments, for example with reference to exemplary FIG. 2, a mounting unit including a stripper bolt 20 and a bushing 10 and a nut 30 coupled to a leading end of the stripper bolt 20 in order will be described.

Preferably, the stripper bolt 20 includes a head portion 21, a body portion 22 provided with an insert portion 23 at a leading end portion thereof, and a male screw-threaded portion 24 protruding from the leading end of the insert portion 23. Preferably, the body portion 22 has a solid bar shape having a diameter slightly smaller than that of the head portion 21. According to exemplary embodiments, the diameter of the body portion 22 is preferably about at least 1.0, 1.25, 1.5, 1.75, 2.0 or more, preferably 1.5 times the diameter of the male screw-threaded portion 24 to endure strong shearing stress. Preferably, the insert portion 23 has a suitably flat surface Which presses the body portion 22. A sill 25 is preferably provided at a border between the body portion 22 and the insert portion 23.

In preferred embodiments, the bushing 10 is a T-shaped member. Preferably, the bushing 10 is structured in a manner such that a flange portion 13 suitably extends from an upper end of the main part 11 through which the penetration hole 12 is formed to extend in the lengthwise direction. According to preferred embodiments of the invention, the main part 11 has a rectangular section and a flat external surface so as to limit rotation of the stripper bolt 20 at a position at which the bushing 10 is placed. Preferably, the penetration hole 12 has a shape corresponding to that of the insert portion 23 and has the substantially same length as the insert portion 23. In further embodiments, rotation of the insertion portion 23 inserted and received in the penetration hole 12 is stopped by coming into plane-contact with the inside surface of a wall thereof. A lower end of the bushing 10 is suitably supported or stopped by the sill 25 of the stripper bolt 20.

According to other further embodiments, the nut 30 is preferably coupled with the male screw-threaded portion 24 of the stripper bolt protruding outside from an end of the penetration hole 12. Preferably, an upper end of the nut 30 is suitably provided with a tapered wing 31 which becomes smaller toward a leading end thereof and has female threads 31a on the inside surface thereof so that the male screw-threaded portion 24 to be mated with the nut 30 is pressed and thus the coupling between the nut 30 and the male screw-threaded portion 24 is suitably unthreaded by vibration.

In further embodiments, members of the mounting unit can be suitably manufactured using cast iron, aluminum alloy, magnesium alloy, or stainless steel having high rigidity and thermal resistance.

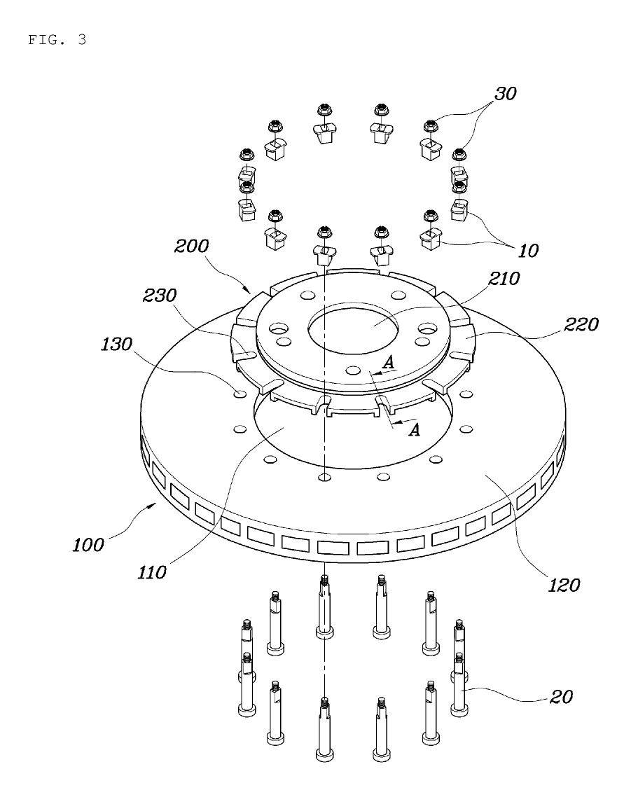

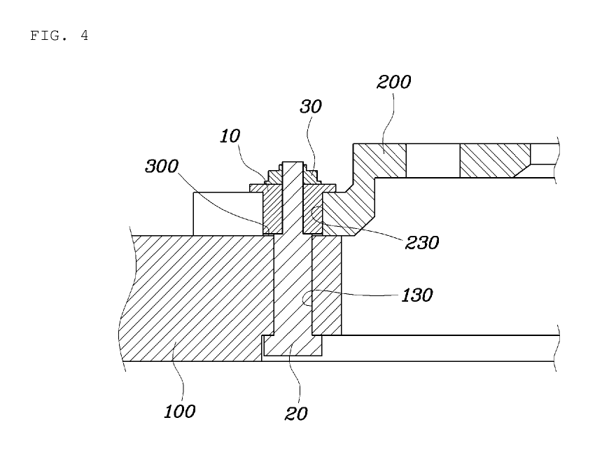

Next, in further embodiments, with reference to exemplary FIGS. 3 and 4, a brake disk in which a rotor hat 200 is installed on a disk rotor 100 using the above-mentioned mounting unit will be described.

In exemplary embodiments, for example as shown in FIG. 3, the disk rotor 100 preferably has a disk shape having a frictional surface 120 with which a brake pad (not shown) is in suitable contact. A center portion of the frictional surface 120 is provided with a center hole 110, and a plurality of lower holes 130 is formed around the center hole 110. Preferably, each of the lower holes 130 has the same shape as the body portion 22 of the stripper bolt 20. According to further preferred embodiments, the disk rotor 100 can be manufactured with a carbon-fiber-reinforced carbon-ceramic (C_{f}/C—SiC) composite,

Preferably, the rotor hat 200 is a linking member which connects the disk rotor 100 to a hub of a wheel of a vehicle (not shown), and preferably has a disk shape provided with a hat center hole 210 at a center portion thereof like the disk rotor 100. A plurality of upper holes 230 is provided around the hat center hole 210. In further preferred embodiments, the upper holes 230 are suitably arranged in a radial shape and each of the upper holes 230 has an open semicircular shape, in certain embodiments, the rotor hat 200 can be manufactured of aluminum alloy, magnesium alloy, or stainless steel to suitably improve high temperature thermal resistance, chemical resistance, anti corrosiveness, and lightweight characteristics.

In further exemplary embodiments, for example as shown in FIGS. 3 and 4, the stripper bolt 20 is preferably installed so as to penetrate through the lower hole 130 and the upper hole 230 in order and the male screw-threaded portion 24 of the stripper bolt 20, which is visible from the outside by protruding from an end of the penetration hole 12, can be suitably mated with the nut 30. When the nut 30 is screwed tightly, the head portion 21 of the stripper bolt 20 suitably presses a lower surface of the disk rotor 100, and the flange portion 13 of the bushing 10 suitably presses the upper surface of the hat center hole 210 of the rotor hat 200. Preferably, the head portion 21 has a larger diameter than a head of a typical bolt, so there is no need for an additional washer.

According to further preferred embodiments, the main part of the bushing 10 received in the upper hole 230 is suitably in plane contact with the inside surface of the upper hole 230 and thus the rotation thereof is stopped. Accordingly, due to a suitable plane contact structure, vibration at a coupling portion between the disk rotor 100 and the rotor hat 200 is alleviated and noise attributable to the vibration suitably decreases. In further embodiments, the lower end of the main part 11 is preferably separated from the rotor hat 200. Accordingly, it is preferable that a gap 300 between the main part 11 and the rotor hat 200 is about 0.01-0.5, preferably 0.05 to 0.1 millimeters. Further, the lower end of the main part 11 is suitably supported or stopped by the sill 25 of the stripper bolt 20. In certain exemplary embodiments, for example with reference to FIG. 4, a length of the main part 11 is smaller than a length or depth of the upper hole 230 by about 0.05 to 0.1 millimeters, and a length of the body portion 22 of the stripper bolt 20 is larger than a length or a depth of the lower hole 130 by about 0.05 to 0.1 millimeters.

In other further exemplary embodiments, for example with reference to FIG. 4, a mechanism of maintaining thermal and mechanical stability at a coupling portion between the disk rotor 100 and the rotor hat 200 is described.

In certain embodiments, the shearing force generated at the border between the disk rotor 100 and the rotor hat 200 is preferably expressed such that force in a positive direction is suitably applied to the body portion 22 from the disk rotor 100 and force in a negative direction is suitably applied to the bushing 10 from the rotor hat 200. Preferably, the shearing force applied to the mounting unit acts so as to cause the stripper bolt 20 to be inclined in one direction. According to certain embodiments, since the bushing 10 is suitably separated from the disk rotor 100 and does not come into direct contact with the disk rotor 100, the force decreases by a considerable amount. Preferably, in certain embodiments, with the force in the positive direction from the rotor hat 200, the bushing 10 can be inclined by just a slight amount an the positive direction regardless of the stripper bolt 20. Such force acting in the positive direction is not just transferred to the stripper bolt 20 as it is. The body portion 22 of the stripper bolt 20 which comes in plane contact with the disk rotor 100 has a bar shape having a relatively large diameter. Accordingly, such a structure of the body portion 20 can help to withstand without suitable difficulty the force applied from the disk rotor 100 in the negative direction. According to other further embodiments, it is expected that the thermal and mechanical stability need adequate tolerance management between the bushing 10 and the upper holes 230, between the insert portion 23 and the penetration hole 12, and between the lower holes 130 and the body portion 22.

Although the preferred embodiments of the invention is described above in detail, it will be apparent to those skilled in the art that various modification and variations may be made without departing from novel concepts or effects of the invention. Thus, it is intended that the present invention cover the modifications and variations of this invention.

1-4. (canceled)

5. A brake disk comprising:
a disk rotor with one or more lower holes provided at a center portion thereof;
a rotor hat with an upper hole which corresponds to the lower hole and is provided at a center portion thereof; and
a mounting unit which couples the rotor hat to the disk rotor,
wherein the mounting unit includes:
a main part received in the upper hole and provided with a penetration hole extending in a lengthwise direction thereof and a flange portion formed to expand from an upper end of the main part, wherein rotation of the main part is limited in the upper hole and a lower end of the main part is separated from the disk rotor; and
a tubular coupling member which penetrates through the lower hole and the penetration hole and has one end fixed to the disk rotor and the other end fixed to rotor hat.

6. The disk brake according to claim 5, wherein rotation of the coupling member inside the penetration hole is limited.

7. The disk brake according to claim 5, wherein the coupling member comprises:
a stripper bolt including a head portion, a body portion provided with an insert portion to be inserted into or received in the penetration hole at a leading end, and a male screw-threaded portion protruding from the leading end of the insert portion, wherein the insert portion and the penetration hole have corresponding shapes so that rotation of the insert portion in the penetration hole is limited.

8. The brake disk according to claim 7, wherein the insert portion has a flat surface in plane contact with an inside surface of the penetration hole.

9. The brake disk according to claim 5, wherein a border between the body portion and the insert portion is provided with a sill which supports or stops a lower end of the bushing.

10-12. (canceled)

13. A brake disk comprising:
a disk rotor with one or more lower holes provided at a center portion thereof;
a rotor hat with an upper hole which corresponds to the lower hole and is provided at a center portion thereof; and
a mounting unit which couples the rotor hat to the disk rotor,
wherein the mounting unit includes:
a main part received in the upper hole and provided with a penetration hole and a flange portion, wherein rotation of the main part is limited in the upper hole and a lower end of the main part is separated from the disk rotor; and
a tubular coupling member.

14. The brake disk of claim 13, wherein the penetration hole of the main part is extending in a lengthwise direction.

15. The brake disk of claim 13, wherein the flange portion of the main part is formed to expand from an upper end of the main part.

16. The brake disk of claim 13, wherein the tubular coupling member penetrates through the lower hole and the penetration hole and has one end fixed to the disk rotor and the other end fixed to rotor hat.

17-18. (canceled)

19. A motor vehicle comprising the brake disk of claim 5.

20. A motor vehicle comprising the brake disk of claim 13.
